(19) United States
(12) Patent Application Publication
(10) Pub. No.: US 2026/0129001 A1
(43) Pub. Date: May 7, 2026

(54) DYNAMIC ALLOCATION OF DEDICATED NETWORK BANDWIDTH FOR USER

(71) Applicant: Boost SubscriberCo L.L.C., Englewood, CO (US)

(72) Inventor: Jeffrey Lang McSchooler, Parker, CO (US)

(21) Appl. No.: 18/937,992

(22) Filed: Nov. 5, 2024

(51) Int. Cl. H04L 47/76; H04N 21/2343

(52) U.S. Cl. CPC H04L 47/76; H04N 21/2343

(57) ABSTRACT

Systems and methods for dynamically allocating dedicating bandwidth to a user. A request for a timeframe of dedicated bandwidth in a cellular network is received from the user. In response to start of the timeframe: a total available bandwidth of the cellular network is determined, as is a remaining available bandwidth for network devices currently using network bandwidth. A determination is made whether the remaining available bandwidth is sufficient or insufficient for the network devices currenting using network bandwidth. And during the timeframe: for each corresponding network device of the identified network devices: an amount of bandwidth available to the corresponding network device is reduced or managed for the timeframe for the dedicated bandwidth if the remaining available bandwidth is insufficient. The dedicated bandwidth is then allocated for the request.

### BACKGROUND

Mobile phones and devices are consistently being using more everyday by more people. As the use of mobile phones and devices increases, so has the desire of bad actors to exploit security vulnerabilities in the software of those mobile phones and devices. As a result, the software on mobile phones needs to be kept up to date and continually monitored. Updating a mobile phone or device often includes using the network to download a software update or patch. Unfortunately, updating very large numbers of mobile phones can use up tremendous amounts of the network’s bandwidth and cause slowdowns or latency issues for more than just the mobile phone or device that is upgrading. It is with respect to these and other considerations that the embodiments described herein have been made.

### BRIEF SUMMARY

Embodiments are directed towards systems and methods for dynamically allocating dedicated network bandwidth for a user at a dedicated timeframe. Briefly, a user or provider request indicates that a user would like dedicated bandwidth within a network, e.g., a cellular network, for a timeframe. During the timeframe, the dedicated bandwidth is allocated user by user, while managing the bandwidth to other network devices connected to the network. In this way, the user or provider can schedule a time period in which it has a dedicated amount of bandwidth of a network, independent of the current bandwidth being used by other network devices.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings:

FIG. 1 illustrates a context diagram of an environment for dynamically allocating dedicated network bandwidth for a user in accordance with embodiments described herein;

FIGS. 2A-2B illustrate a logical flow diagram showing one embodiment of a process for dynamically allocating dedicated network bandwidth for a user in accordance with embodiments described herein; and

FIG. 3 shows a system diagram that describe various implementations of computing systems for implementing embodiments described herein.

### DETAILED DESCRIPTION

The following description, along with the accompanying drawings, sets forth certain specific details in order to provide a thorough understanding of various disclosed embodiments. However, one skilled in the relevant art will recognize that the disclosed embodiments may be practiced in various combinations, without one or more of these specific details, or with other methods, components, devices, materials, etc. In other instances, well-known structures or components that are associated with the environment of the present disclosure, including but not limited to the communication systems and networks, have not been shown or described in order to avoid unnecessarily obscuring descriptions of the embodiments. Additionally, the various embodiments may be methods, systems, media, or devices. Accordingly, the various embodiments may be entirely hardware embodiments, entirely software embodiments, or embodiments combining software and hardware aspects.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

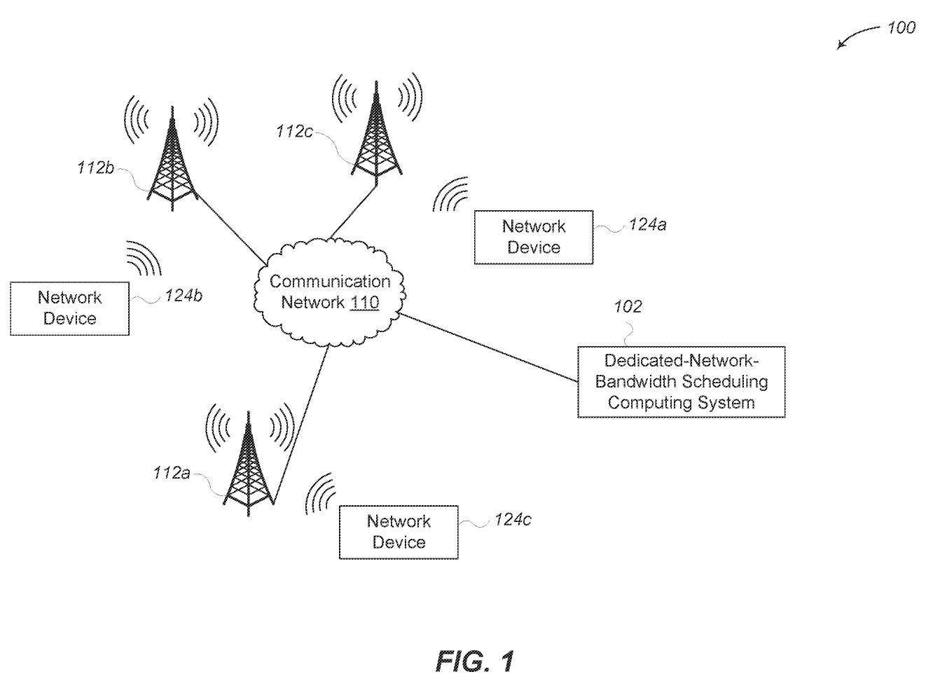

FIG. 1 illustrates a context diagram of an environment for dynamically allocating dedicated network bandwidth for a user in accordance with embodiments described herein. Environment 100 includes a plurality of cells 112a-112c, a plurality of network devices 124a-124c, a dedicated-network-bandwidth scheduling computing system 102, and a communication network 110.

The network devices 124a-124c are computing devices that receive and transmit communication messages or data within a network, such as a wireless or cellular network. Network devices 124a-124c may be referred to as mobile devices, mobile computing devices, wireless stationary devices, user equipment, or some combination thereof, or other similar terminology. Examples of network devices 124a-124c may include, but are not limited to, mobile phones, smartphones, tablets, cellular-enabled laptop computers, cellular-enabled desktop computers, Internet-of-Things devices, or other mobile or stationary computing devices that utilize a wireless network. As one illustrative example, network devices 124a-124c may be mobile devices that are configured to receive and transmit cellular communications with the cells 112a-112c. The network devices 124a-124c may be individually or collectively referred to as network device 124 or network devices 124.

The cells 112a-112c are cellular towers that together provide the hardware infrastructure of a cellular communications network, e.g., a 5G cellular communications network. The cells 112a-112c may include or be in communication with base stations, radio back haul equipment, antennas, or other devices, which are not illustrated for ease of discussion. In various embodiments, the cells 112a-112c may communicate with each other via communication network 110. The cells 112a-112c may be individually or collectively referred to as cell 112 or cells 112. Communication network 110 includes one or more wired or wireless networks, which may include a series of smaller or private connected networks that carry information between the cells 112a-112c. In some embodiments, the cells 112a-112c and the communication network 110, along with other networking components not illustrated, may collectively be referred to as a wireless network or a cellular communication network that supports embodiments described herein.

The dedicated-network-bandwidth scheduling computing system 102 is a computing device or cloud computing environment within a wireless network that manages or coordinates the dynamic allocation of dedicating bandwidth within the wireless network to one or more users. In various embodiments, the dedicated-network-bandwidth scheduling computing system 102 provides a graphical user interface or application to a user, where the user can select and schedule a timeframe in which they have a dedicated amount of bandwidth within the wireless network. The dedicated-network-bandwidth scheduling computing system 102 can employ embodiments described herein to implement the dynamically scheduled dedicated bandwidth for the user. As used herein, “user” refers to the person, persons, organization, company, or entity that utilizes the dedicated-network-bandwidth scheduling computing system 102 to schedule dedicated bandwidth or the person, persons, organization, company, or entity that utilizes the dedicated bandwidth. Examples of users may include, but are not limited to, a network device manufacturer, emergency services, a government entity, a government agency, a paying network client, a network administrator, etc.

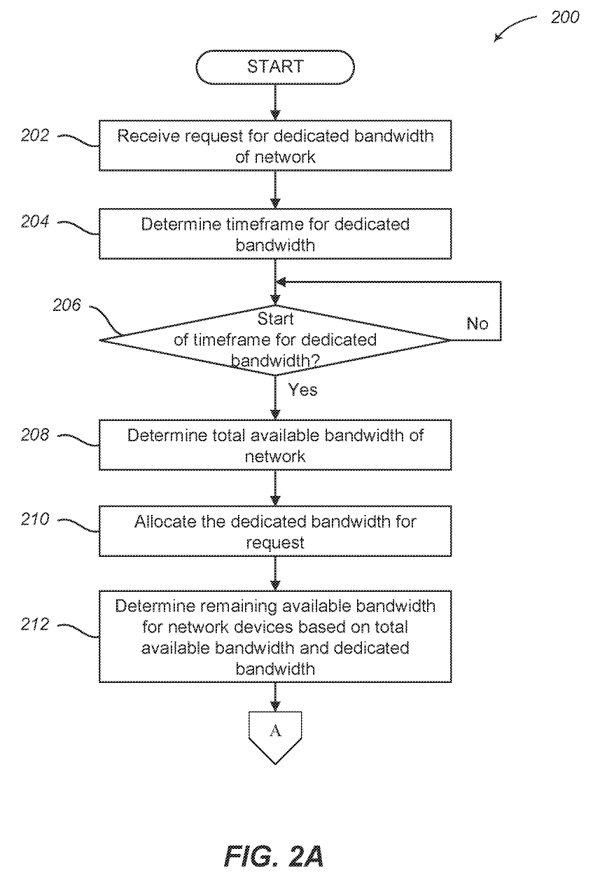

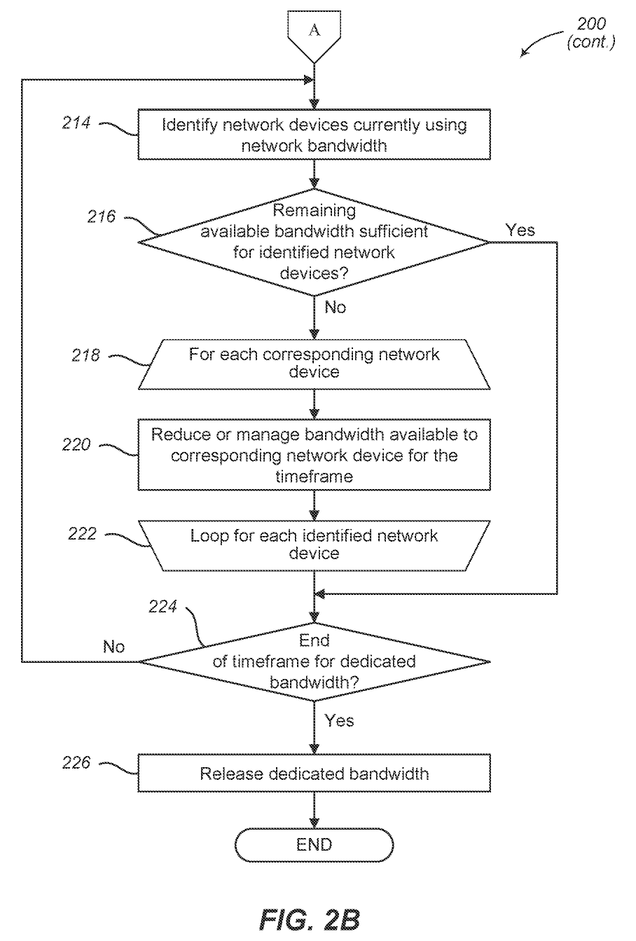

The operation of certain aspects will now be described with respect to FIGS. 2A-2B. FIGS. 2A-2B illustrate a logical flow diagram showing one embodiment of a process 200 for dynamically allocating dedicated network bandwidth for a user in accordance with embodiments described herein. Process 200 may be implemented by or executed via circuitry on one or more computing devices, such as dedicated-network-bandwidth scheduling computing system 102 in FIG. 1.

Process 200 begins, after a start block in FIG. 2A, at block 202, where a request is received from a user for dedicated bandwidth of one or more networks. The request may identify an amount of dedicated bandwidth and a timeframe for the dedicated bandwidth. In some embodiments, the amount of dedicated bandwidth may be a number of bytes that need to be transmitted across the network. In other embodiments, the amount of dedicated bandwidth may be a percentage of the total available bandwidth of the network, such as 40% of the total available bandwidth. In at least one embodiment, the total available bandwidth for a network, also referred to as the possible network bandwidth, is the total amount of data that can be transmitted across the network during the timeframe, independent of the current network usage of network devices connected to the network.

In some embodiments, the timeframe for the dedicated bandwidth may include a start time and an end time for the dedicated bandwidth, such as a day and time indicating the start of when the network bandwidth is dedicated for the user and a day and time indicating the end of when the network bandwidth is dedicated for the user. In other embodiments, the timeframe may identify a start time and a duration or time period for the dedicated bandwidth, such as a day and time indicating the start of when the network bandwidth is dedicated for the user and the number of minutes or hours in which the network bandwidth is dedicated for the user. In yet other embodiments, the timeframe may indicate a start time for the dedicated bandwidth, without indicating the end time. In such an embodiment, the end time may occur when the user indicates that it is done using the dedicated bandwidth, or when a task is completed during the dedicated bandwidth (e.g., a software download is complete), or when a threshold amount of data has been transmitted across the network. The start time or end time may be an actual day or time in the future or immediately upon receipt of the request.

In various embodiments, the request may also identify other information related to the dedicated bandwidth. For example, in some embodiments, the request may identify one network or a plurality of networks in which bandwidth is to be dedicated for the user. In other embodiments, the request may identify a portion, but not all, of the network. For example, the request may indicate that the user needs dedicated bandwidth in a particular geographic area, in a particular neighborhood, in a particular coverage area of the network, in a particular market, from a particular set of one or more cells in the network, etc.

In various embodiments, the user may be a network device manufacturer, emergency services, a government entity, a government agency, a paying network client, etc. In at least one embodiment, the user may be presented with a graphical user interface from which the user can select or define the amount of dedicated bandwidth and the timeframe for the dedicated bandwidth (and any other information related to the request). In other embodiments, an administrator of the network may define or set the request for the user. As one illustrative example, the user may be a mobile device manufacturer, such as Apple®. The mobile device manufacturer may have identified a security vulnerability with a specific type of mobile device or specific software running on mobile devices. The mobile device manufacturer may need to download and install a software or firmware update on each mobile device that is susceptible to the security vulnerability. The mobile device manufacturer can use the graphical user interface to schedule dedicated bandwidth on the network for the software or firmware update to be transmitted to the susceptible mobile device, such as 30% of the network bandwidth at 2:00 am local time (current time at the location of the mobile device). As another illustrative example, the user may a government agency, such as the FBI (Federal Bureau of Investigation). In the event that the FBI needs to respond to a national emergency, the FBI may request that the network dedicate 25% of the total available network bandwidth to the FBI for the next 24 hours, which can be set and scheduled by an administrator of the network.

Process 200 proceeds, after block 202, to block 204, where a timeframe for the dedicated bandwidth is determined. As noted above, the timeframe may be included with the request. In other embodiments, the timeframe may be calculated based on the amount of dedicated bandwidth and the historical usage of the network. For example, if the user needs a dedicated 70% of the total available bandwidth for 15 minutes, then the system can determine the time of day, or the day of the week, that is most likely to accommodate or come close to accommodating those criteria using historical network usage data.

Process 200 continues, after block 204, at decision block 206, where a determination is made whether the timeframe for the dedicated bandwidth has started. In at least one embodiment, the current local time where the dedicated network bandwidth is to be used (e.g., local time of cells of the network, local time of the geographic area, local time of network devices to receive data using the dedicated bandwidth, etc.) is compared to the request. If there is a match, then the timeframe has started. If the timeframe has started, process 200 flows to block 208; otherwise, process 200 loops to decision block 206 to wait for the start of the timeframe for the dedicated bandwidth.

At block 208, a total available bandwidth of the network is determined. As noted above, the total available bandwidth for the network, also referred to as the possible network bandwidth, is the total amount of data that can be transmitted across the network during the timeframe, independent of the current network usage of network devices connected to the network. Because the request for the dedicated bandwidth can be for a particular geographic area, in a particular neighborhood, in a particular coverage area of the network, in a particular market, from a particular set of one or more cells in the network, etc., the total available bandwidth is the total available bandwidth for that particular geographic area, that particular neighborhood, that particular coverage area of the network, that particular market, that particular set of one or more cells in the network, etc.

Process 200 proceeds, after block 208, to block 210, where the dedicated bandwidth is allocated for the request. In some embodiments, allocating the dedicated bandwidth for the user includes transmitting a command to each cell in the network (or portion of the network identified by the request) indicating that the dedicated amount of bandwidth is to be reserved for the user, regardless of whether the user actually uses that bandwidth or not.

Process 200 continues, after block 210, to block 212, where the remaining available bandwidth is determined based on the total available bandwidth and the dedicated bandwidth. In at least one embodiment, the remaining available bandwidth is the difference between the total available bandwidth and the dedicated bandwidth. For example, if the dedicated bandwidth is 40% of the total available bandwidth, then 60% of the total available network bandwidth is the remaining available bandwidth.

Process 200 continues, after block 212, at block 214 in FIG. 2B, where network devices currently using network bandwidth are identified. In some embodiments, each cell of the network is queried to identify those network devices currently using the network. In various embodiments, the current network bandwidth being used by those identified network devices is also determined. In at least one embodiment, the cells of the network are instructed to monitor the network devices to determine their current bandwidth or to query the identified network devices for their current bandwidth usage (or their predicted bandwidth usage during the timeframe of the dedicated bandwidth.

Process 200 proceeds, after block 214, to decision block 216, where a determination is made whether the remaining available bandwidth is sufficient for the identified network devices. In various embodiments, the current network bandwidth being used by the identified network devices is calculated. If the current network bandwidth is less than the remaining available bandwidth, then the remaining available bandwidth is sufficient for the identified network devices. But if the current network bandwidth is greater than the remaining available bandwidth, then the remaining available bandwidth is insufficient for the identified network devices. If the remaining available bandwidth is sufficient, then process 200 flows to block 224; otherwise, process 200 flows to block 218.

At block 218, each corresponding network device is selected from the identified network devices to be processed.

For each corresponding network device, process 200 proceeds, after block 218, to block 220, where the bandwidth that is available to the corresponding network device is reduced or managed for the timeframe for the dedicated bandwidth. In some embodiments, the corresponding network device is instructed to modify a current video or audio codec being used by the corresponding network device. This modification is to select and employ a different video or audio codec that uses less bandwidth.

In some embodiments, the amount of reduced or managed available bandwidth for the corresponding network device is proportionally distributed among the number of identified network devices. For example, each corresponding network device may be instructed to reduce or manage its bandwidth utilization by 6%, where the percentage reduction is to keep the available bandwidth for the identified network devices below the remaining available bandwidth.

In other embodiments, the amount of reduced or managed available bandwidth for the corresponding network device may be based on the service level agreement that the corresponding network device has with the network. For example, assume a first network device has a first service level agreement with the network and a second network device has a second service level agreement with the network. In this example, the reduced or managed amount of bandwidth available to the first network device may be a first amount based on the first service level agreement and the reduced or managed amount of bandwidth available to the second network device may be a second amount based on the second service level agreement, where the second amount is less than the first amount.

In some other embodiments, the amount of reduced or managed available bandwidth for the corresponding network device may be based on the distance between the corresponding network device and the network cell, or cellular tower, to which it is connected. For example, assume a first network device is a first distance away from the cell and a second network device is a second distance away from the cell. In this example, the reduced or managed amount of bandwidth available to the first network device may be a first amount based on the first distance and the reduced or managed amount of bandwidth available to the second network device may be a second amount based on the second distance, where the second amount is less than the first amount.

In other embodiments, the network may automatically reduce or manage the amount of bandwidth available to the corresponding network device. In at least one such embodiment, the network may broadcast or report the reduced or managed amount of bandwidth to the corresponding network device. In this way, the corresponding network device can request data from the network based on that reduced or managed amount without being explicitly instructed to reduce or manage the amount of bandwidth the corresponding network device is using. In yet other embodiments, the cells themselves may automatically adjust how data is being transmitted to the corresponding network device so that the cell is causing the corresponding network device to use a reduced or managed amount of bandwidth.

Process 200 continues, after block 220, at block 222, which loops to block 218 to process each corresponding identified network device that is currently using network bandwidth.

After block 222, process 200 continues at decision block 224, where a determination is made whether the timeframe for the dedicated bandwidth has ended. In some embodiments, the current local time where the dedicated network bandwidth is to be used (e.g., local time of cells of the network, local time of the geographic area, etc.) is compared to the request. If there is a match between the current local time and the end time in the request, then the timeframe has ended. In other embodiments, an amount of time that has lapsed since the start of the timeframe is determined and compared to a time period identified in the request. If there is a match between the lapse time and the time period in the request, then the timeframe has ended. In some other embodiments, the amount of dedicated bandwidth used by the user during the timeframe is compared to the request. If there is a match between the amount of dedicated bandwidth used and the amount in the request, then the timeframe has ended. In yet another embodiment, the system checks on whether the user has provided a command or indication that it is done using the dedicated bandwidth.

If the timeframe has ended, then process 200 flows to block 226; otherwise, process 200 loops to block 214. By looping to block 214, process 200 can dynamically determine the network devices currently using network bandwidth as network devices start to use network bandwidth or stop using network bandwidth. This dynamic determination can be used to dynamically determine when to reduce or manage, or not reduce or manage, the bandwidth that is available to those network devices.

At block 226 after the timeframe has ended, the dedicated bandwidth is release, and network devices are allowed to resume use of their normal available bandwidth. In some embodiments, the identified network devices are informed that there is now more available bandwidth that they can use. In other embodiments, the network may automatically return to the normal bandwidth utilization prior to the start of the timeframe.

After block 226, process 200 terminates or otherwise returns to a calling process to perform other actions. In some embodiments, process 200 may loop (not illustrated) from block 226 to decision block 206 in FIG. 2A to wait for a next start of the timeframe (e.g., if the timeframe for dedicated bandwidth is at select periodic intervals, such as every Sunday morning at 2:00 am local time).

Although process 200 describes the scheduling of dedicated bandwidth for a specific user, embodiments are not so limited. Rather, process 200 may be performed to schedule dedicated bandwidth for a plurality of users. Those schedules (i.e., the timeframes for the dedicated bandwidth) may be non-overlapping with one another, or they may partially overlap with one another, or they may fully overlap with one another. In situations where there are overlapping schedules, the system may cause the users to employ separate network slicing for their dedicated bandwidth. A network slice may be comprising an end-to-end logical communications network or architecture that extends from a network device (e.g., network device 124) to the network. A network slice may comprise a set of network functions that are selected to provide specific telecommunications services, such as to enable one user to use its dedicated bandwidth separate from another user suing its dedicated bandwidth.

In some other situations, a user may utilize separate network slices for different groups of network devices during the dedicated bandwidth timeframe. For example, a first type of network device may utilize a first network slice to receive a first software update from the user, and a second type of network device may utilize a second network slice to receive a second software update from the user. In this way, the user can balance its dedicated bandwidth across multiple slices to communicate with different types of network devices.

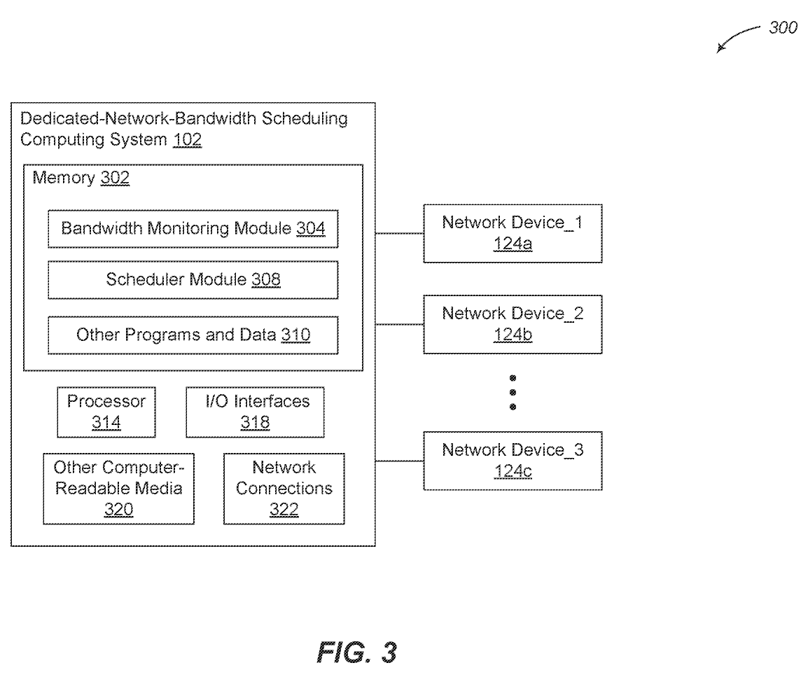

FIG. 3 shows a system diagram that describe various implementations of computing systems for implementing embodiments described herein. System 300 includes a dedicated-network-bandwidth scheduling computing system 102 and network devices 124a-124c.

The dedicated-network-bandwidth scheduling computing system 102 is a computing system or environment that obtains or receives a request to provide dedicated network bandwidth to a user for a timeframe. During the timeframe, the dedicated-network-bandwidth scheduling computing system 102 causes the network devices 124a-124c to use a reduced or managed amount of network bandwidth to ensure that the user has access to the dedicated amount of bandwidth, as described herein. One or more special-purpose computing systems may be used to implement the dedicated-network-bandwidth scheduling computing system 102. Accordingly, various embodiments described herein may be implemented in software, hardware, firmware, or in some combination thereof. The dedicated-network-bandwidth scheduling computing system 102 includes memory 302, processor 314, I/O interfaces 318, other computer-readable media 320, and network connections 322.

Processor 314 includes one or more processors, one or more processing units, programmable logic, circuitry, or one or more other computing components that are configured to perform embodiments described herein or to execute computer instructions to perform embodiments described herein. In some embodiments, a processor system of the dedicated-network-bandwidth scheduling computing system 102 may include a single processor 314 that operates individually to perform actions. In other embodiments, a processor system of the dedicated-network-bandwidth scheduling computing system 102 may include a plurality of processors 314 that operate to collectively perform actions, such that one or more processors 314 may operate to perform some, but not all, of such actions. Reference herein to “a processor system” of the dedicated-network-bandwidth scheduling computing system 102 refers to one or more processors 314 that individually or collectively perform actions. And reference herein to “the processor system” of the dedicated-network-bandwidth scheduling computing system 102 refers to 1) a subset or all of the one or more processors 314 comprised by “a processor system” of the dedicated-network-bandwidth scheduling computing system 102 and 2) any combination of the one or more processors 314 comprised by “a processor system” of the dedicated-network-bandwidth scheduling computing system 102 and one or more other processors 314.

Memory 302 may include one or more various types of non-volatile and/or volatile storage technologies. Examples of memory 302 may include, but are not limited to, flash memory, hard disk drives, optical drives, solid-state drives, various types of random-access memory (RAM), various types of read-only memory (ROM), other computer-readable storage media (also referred to as processor-readable storage media), or the like, or any combination thereof. Memory 302 may be utilized to store information, including computer-readable instructions that are utilized by processor 314 to perform actions, including embodiments described herein.

Memory 302 may have stored thereon bandwidth monitoring module 304 and scheduler module 308. The bandwidth monitoring module 304 is configured to determine a total amount available network bandwidth and to determine the current amount of bandwidth being utilized by the network devices 124a-124c. The scheduler module 308 is configured to receive a request to provide a dedicated amount of bandwidth to a user for a selected timeframe. In some embodiments, the scheduler module 308 may be configured to provide a graphical user interface to the user so that the user can schedule the dedicated bandwidth for the timeframe. Once scheduled, the scheduler module 308 is configured to instruct the network or the network devices 124a-124c to use a reduced or managed amount of bandwidth for the duration of the timeframe so that the dedicated bandwidth is guaranteed for the user for the duration of the timeframe. Although the bandwidth monitoring module 304 and the scheduler module 308 are illustrated as separate modules, embodiments are not so limited. Rather one module or a plurality of modules may be employed to perform the functionality of the bandwidth monitoring module 304 and the scheduler module 308. These modules may be software, hardware, or some combination thereof that together perform the functionality described herein.

Memory 302 may also store other programs and data 310 (e.g., user information, dedicated bandwidth schedules for one or more users, network device information, operating systems, etc.)

Network connections 322 are configured to communicate with other computing devices, such as network devices 124a-124c. In various embodiments, the network connections 322 include transmitters and receivers (not illustrated) to send and receive data as described herein. I/O interfaces 318 may include one or more data input or output interfaces, video or display interfaces, or other input/output interfaces. Other computer-readable media 320 may include other types of stationary or removable computer-readable media, such as removable flash drives, external hard drives, or the like.

The network devices 124a-124c may include computing components similar to dedicated-network-bandwidth scheduling computing system 102, but are not shown in FIG. 3 for ease of discussion.

The following is a summarization of the original claims as filed.

A method may be summarized as comprising: receiving a request for dedicated bandwidth in a cellular network; determining a timeframe for the dedicated bandwidth; in response to start of the timeframe: determining a total available bandwidth of the cellular network; determining remaining available bandwidth for network devices based on a comparison between the total available bandwidth and the dedicated bandwidth; identifying network devices currently using network bandwidth; and determining that the remaining available bandwidth is insufficient for the identified network devices. And during the timeframe: for each corresponding network device of the identified network devices: reducing or managing an amount of bandwidth available to the corresponding network device for the timeframe for the dedicated bandwidth; and allocating the dedicated bandwidth for the request.

The method may reduce or manage the amount of bandwidth available to the corresponding network device by: determining a first voice codec currently being used by the corresponding network device; and selecting a second voice codec for the corresponding network device to use during the timeframe for the dedicated bandwidth, wherein the second voice codec results in use of less bandwidth than the first voice codec.

The method may reduce or manage the amount of bandwidth available to the corresponding network device by: determining a first video codec currently being used to transmit video data to the corresponding network device; and selecting a second video codec for transmitting video data to the corresponding network device during the timeframe for the dedicated bandwidth, wherein the second video codec results in use of less bandwidth than the first video codec.

The method may reduce or manage the amount of bandwidth available to the corresponding network device by: identifying a first service level agreement with a first network device; identifying a second service level agreement with a second network device; reducing, for the timeframe for the dedicated bandwidth, the amount of bandwidth available to the first network device a first amount based on the first service level agreement; and reducing, for the timeframe for the dedicated bandwidth, the amount of bandwidth available to the second network device a second amount based on the second service level agreement, wherein the second amount is less than the first amount.

The method may reduce or manage the amount of bandwidth available to the corresponding network device by: identifying a first network device that is a first distance away from a cellular tower; identifying a second network device that is a second distance away from the cellular tower; reducing the amount of bandwidth available to the first network device a first amount for the timeframe based on the first distance; and reducing the amount of bandwidth available to the second network device a second amount for the timeframe based on the second distance, wherein the second amount is less than the first amount.

The method may reduce or manage the amount of bandwidth available to the corresponding network device by: instructing the corresponding network device to employ a video codec or a voice codec that utilizes less bandwidth during the timeframe for the dedicated bandwidth compared to the video codec or the voice codec being used by the corresponding network device prior to the timeframe.

The method may reduce or manage the amount of bandwidth available to the corresponding network device by: instructing the corresponding network device of the reduced or managed amount of bandwidth available to the corresponding network device during the timeframe for the dedicated bandwidth.

The method may receive the request for the dedicated bandwidth in the cellular network by: providing a graphical use interface to a user; and receiving input from the user indicating an amount of dedicated bandwidth and the timeframe for the dedicated bandwidth. In some embodiments, the user may comprise at least one of a network device manufacturer, emergency services, a government entity, or a paying network client.

The method may allocate the dedicated bandwidth for the request by: identifying a plurality of network devices that are running an out-of-date version of software; and causing the plurality of network devices to download and install an up-to-date version of the software during the timeframe for the dedicated bandwidth.

The method may identify the network devices currently using network bandwidth by: identifying a plurality of network devices that are currently using network bandwidth; and selecting a subset of the plurality of network devices to reduce or manage bandwidth during the timeframe for the dedicated bandwidth.

A computing system may be summarized as comprising: a memory that stores computer instructions; and a processor system that executes the computer instructions to: receive a request for a timeframe for dedicated bandwidth in a wireless network; and during the timeframe: determine a total available bandwidth of the cellular network; determine remaining available bandwidth for network devices based on a comparison between the total available bandwidth and the dedicated bandwidth; determine that the remaining available bandwidth is insufficient for network devices currently using bandwidth of the wireless network; for each corresponding network device currently using bandwidth of the wireless network, reduce or manage an amount of bandwidth available to the corresponding network device for the timeframe for the dedicated bandwidth; and allocate the dedicated bandwidth for the request.

The processor system of the computing system may reduce or manage the amount of bandwidth available to the corresponding network device by further executing the computer instructions to: determine a first voice codec currently being used by the corresponding network device; and select a second voice codec for the corresponding network device to use during the timeframe for the dedicated bandwidth, wherein the second voice codec results in use of less bandwidth or bandwidth management than the first voice codec.

The processor system of the computing system may reduce or manage the amount of bandwidth available to the corresponding network device by further executing the computer instructions to: determine a first video codec currently being used to transmit video data to the corresponding network device; and select a second video codec for transmitting video data to the corresponding network device during the timeframe for the dedicated bandwidth, wherein the second video codec results in use of less bandwidth or bandwidth management than the first video codec.

The processor system of the computing system may reduce or manage the amount of bandwidth available to the corresponding network device by further executing the computer instructions to: identify a first service level agreement with a first network device; identify a second service level agreement with a second network device; reduce or manage, for the timeframe for the dedicated bandwidth, the amount of bandwidth available to the first network device a first amount based on the first service level agreement; and reduce or manage, for the timeframe for the dedicated bandwidth, the amount of bandwidth available to the second network device a second amount based on the second service level agreement, wherein the second amount is less than the first amount.

The processor system of the computing system may reduce the amount of bandwidth available to the corresponding network device by further executing the computer instructions to: instruct the corresponding network device to employ a video codec or a voice codec that utilizes less bandwidth during the timeframe for the dedicated bandwidth compared to the video codec or the voice codec being used by the corresponding network device prior to the timeframe.

The processor system of the computing system may reduce or manage the amount of bandwidth available to the corresponding network device by further executing the computer instructions to: instruct the corresponding network device of the reduced or managed amount of bandwidth available to the corresponding network device during the timeframe for the dedicated bandwidth.

The processor system of the computing system may receive the request for the dedicated bandwidth in the cellular network by further executing the computer instructions to: provide a graphical use interface to a user; and receive input from the user indicating an amount of dedicated bandwidth and the timeframe for the dedicated bandwidth.

The processor system of the computing system allocates the dedicated bandwidth for the request by further executing the computer instructions to: identify a plurality of network devices that are running an out-of-date version of software; and provide an up-to-date version of the software to the plurality of network devices during the timeframe for the dedicated bandwidth.

A non-transitory computer-readable medium may be summarized as storing computer instructions that, when executed by at least one processor, cause the at least one processor to perform actions, the actions comprising: receiving a request for a time in which an amount of bandwidth is dedicated for a select user; for the time in which bandwidth is dedicated for the select user: for each corresponding network device currently using network bandwidth, reduce or manage an amount of bandwidth available to the corresponding network device; and allocate the amount of bandwidth dedicated for the select user.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method, comprising:
receiving a request for dedicated bandwidth in a cellular network;
determining a timeframe for the dedicated bandwidth;
in response to start of the timeframe:
determining a total available bandwidth of the cellular network;
determining remaining available bandwidth for network devices based on a comparison between the total available bandwidth and the dedicated bandwidth;
identifying network devices currently using network bandwidth; and
determining that the remaining available bandwidth is insufficient for the identified network devices; and
during the timeframe:
for each corresponding network device of the identified network devices:
reducing or managing an amount of bandwidth available to the corresponding network device for the timeframe for the dedicated bandwidth; and
allocating the dedicated bandwidth for the request.

2. The method of claim 1, wherein reducing or managing the amount of bandwidth available to the corresponding network device comprises:
determining a first voice codec currently being used by the corresponding network device; and
selecting a second voice codec for the corresponding network device to use during the timeframe for the dedicated bandwidth, wherein the second voice codec results in use of less bandwidth than the first voice codec.

3. The method of claim 1, wherein reducing or managing the amount of bandwidth available to the corresponding network device comprises:
determining a first video codec currently being used to transmit video data to the corresponding network device; and
selecting a second video codec for transmitting video data to the corresponding network device during the timeframe for the dedicated bandwidth, wherein the second video codec results in use of less bandwidth than the first video codec.

4. The method of claim 1, wherein reducing or managing the amount of bandwidth available to the corresponding network device comprises:
identifying a first service level agreement with a first network device;
identifying a second service level agreement with a second network device;
reducing, for the timeframe for the dedicated bandwidth, the amount of bandwidth available to the first network device a first amount based on the first service level agreement; and
reducing, for the timeframe for the dedicated bandwidth, the amount of bandwidth available to the second network device a second amount based on the second service level agreement, wherein the second amount is less than the first amount.

5. The method of claim 1, wherein reducing or managing the amount of bandwidth available to the corresponding network device comprises:
identifying a first network device that is a first distance away from a cellular tower;
identifying a second network device that is a second distance away from the cellular tower;
reducing the amount of bandwidth available to the first network device a first amount for the timeframe based on the first distance; and
reducing the amount of bandwidth available to the second network device a second amount for the timeframe based on the second distance, wherein the second amount is less than the first amount.

6. The method of claim 1, wherein reducing or managing the amount of bandwidth available to the corresponding network device comprises:
instructing the corresponding network device to employ a video codec or a voice codec that utilizes less bandwidth during the timeframe for the dedicated bandwidth compared to the video codec or the voice codec being used by the corresponding network device prior to the timeframe.

7. The method of claim 1, wherein reducing or managing the amount of bandwidth available to the corresponding network device comprises:
instructing the corresponding network device of the reduced or managed amount of bandwidth available to the corresponding network device during the timeframe for the dedicated bandwidth.

8. The method of claim 1, wherein receiving the request for the dedicated bandwidth in the cellular network comprises:
providing a graphical use interface to a user; and
receiving input from the user indicating an amount of dedicated bandwidth and the timeframe for the dedicated bandwidth.

9. The method of claim 8, wherein the user comprises at least one of a network device manufacturer, emergency services, a government entity, or a paying network client.

10. The method of claim 1, wherein allocating the dedicated bandwidth for the request comprises:
identifying a plurality of network devices that are running an out-of-date version of software; and
causing the plurality of network devices to download and install an up-to-date version of the software during the timeframe for the dedicated bandwidth.

11. The method of claim 1, wherein identifying the network devices currently using network bandwidth comprises:
identifying a plurality of network devices that are currently using network bandwidth; and
selecting a subset of the plurality of network devices to reduce or manage bandwidth during the timeframe for the dedicated bandwidth.

12. A computing system, comprising:
a memory that stores computer instructions; and
a processor system that executes the computer instructions to:
receive a request for a timeframe for dedicated bandwidth in a wireless network; and
during the timeframe:
determine a total available bandwidth of the cellular network;
determine remaining available bandwidth for network devices based on a comparison between the total available bandwidth and the dedicated bandwidth;
determine that the remaining available bandwidth is insufficient for network devices currently using bandwidth of the wireless network;
for each corresponding network device currently using bandwidth of the wireless network, reduce or manage an amount of bandwidth available to the corresponding network device for the timeframe for the dedicated bandwidth; and
allocate the dedicated bandwidth for the request.

13. The computing system of claim 11, wherein the processor system reduces or manages the amount of bandwidth available to the corresponding network device by further executing the computer instructions to:
determine a first voice codec currently being used by the corresponding network device; and
select a second voice codec for the corresponding network device to use during the timeframe for the dedicated bandwidth, wherein the second voice codec results in use of less bandwidth or bandwidth management than the first voice codec.

14. The computing system of claim 11, wherein the processor system reduces or manages the amount of bandwidth available to the corresponding network device by further executing the computer instructions to:
determine a first video codec currently being used to transmit video data to the corresponding network device; and
select a second video codec for transmitting video data to the corresponding network device during the timeframe for the dedicated bandwidth, wherein the second video codec results in use of less bandwidth or bandwidth management than the first video codec.

15. The computing system of claim 11, wherein the processor system reduces or manages the amount of bandwidth available to the corresponding network device by further executing the computer instructions to:
identify a first service level agreement with a first network device;
identify a second service level agreement with a second network device;
reduce or manage, for the timeframe for the dedicated bandwidth, the amount of bandwidth available to the first network device a first amount based on the first service level agreement; and
reduce or manage, for the timeframe for the dedicated bandwidth, the amount of bandwidth available to the second network device a second amount based on the second service level agreement, wherein the second amount is less than the first amount.

16. The computing system of claim 11, wherein the processor system reduces or manages the amount of bandwidth available to the corresponding network device by further executing the computer instructions to:
instruct the corresponding network device to employ a video codec or a voice codec that utilizes less bandwidth during the timeframe for the dedicated bandwidth compared to the video codec or the voice codec being used by the corresponding network device prior to the timeframe.

17. The computing system of claim 11, wherein the processor system reduces or manages the amount of bandwidth available to the corresponding network device by further executing the computer instructions to:
instruct the corresponding network device of the reduced or managed amount of bandwidth available to the corresponding network device during the timeframe for the dedicated bandwidth.

18. The computing system of claim 11, wherein the processor system receives the request for the dedicated bandwidth in the cellular network by further executing the computer instructions to:
provide a graphical use interface to a user; and
receive input from the user indicating an amount of dedicated bandwidth and the timeframe for the dedicated bandwidth.

19. The computing system of claim 11, wherein the processor system allocates the dedicated bandwidth for the request by further executing the computer instructions to:
identify a plurality of network devices that are running an out-of-date version of software; and
provide an up-to-date version of the software to the plurality of network devices during the timeframe for the dedicated bandwidth.

20. A non-transitory computer-readable medium storing computer instructions that, when executed by at least one processor, cause the at least one processor to perform actions, the actions comprising:
receiving a request for a time in which an amount of bandwidth is dedicated for a select user;
for the time in which bandwidth is dedicated for the select user:
for each corresponding network device currently using network bandwidth, reduce or manage an amount of bandwidth available to the corresponding network device; and
allocate the amount of bandwidth dedicated for the select user.
